(19) United States
(12) Patent Application Publication
(10) Pub. No.: US 2006/0255765 A1
(43) Pub. Date: Nov. 16, 2006

(54) Energy storage

(76) Inventor: Johan Lindstrom, Nykoping (SE)

Correspondence Address: OSTROLENK FABER GERB & SOFFEN, 1180 AVENUE OF THE AMERICAS, NEW YORK, NY, 100368403, US

(21) Appl. No.: 10/557,666

(22) PCT Filed: Apr. 29, 2004
(86) PCT No.: PCT/SE04/00657

§ 371 Date: Dec. 13, 2005

(30) Foreign Application Priority Data
May 22, 2003 (SE) 0301507-0

(51) Int. Cl. H01M 10/46; H02J 7/00

(52) U.S. Cl. 320/125; 320/107

(57) ABSTRACT

The present invention relates to storage of electrical energy in a number of electrical storage modules, which are connected in series to one another. A DC-system voltage (V_{TOT}) is received and DC-to-DC converted into one voltage fraction (V₁, V₂) per electrical storage module. The respective voltage fractions (V₁, V₂) are delivered to each module and varied over time (t) within an interval (V_{D}) around a respective nominal module voltage (V₁ₙ, V₂ₙ). Thereby, the charging voltage is temporarily increased to a level which is sufficiently high to obtain an improved load capacity for each module. At the same time, the overall voltage over the electrical storage modules may be held at a harmless level with respect to any units that are included in the relevant electric circuitry.

### THE BACKGROUND OF THE INVENTION AND PRIOR ART

The present invention relates generally to storage of electrical energy. More particularly the invention relates to an arrangement according to the preamble of claim 1 and a vehicle according to claim 9. The invention also relates to a method of charging a number of electrical storage modules according to the preamble of claim 10, a computer program according to claim 15 and a computer readable medium according to claim 16.

Recent technology development has placed a strong demand for efficient electrical power sources. For instance, in today's vehicular industry it is particularly important that any onboard generated electrical energy can be stored as efficiently as possible and constitute a reliable source of energy. Namely, the functionality of the modern vehicles is very dependent on electrically powered equipment. Moreover, hybrid vehicles and purely electrically propelled vehicles now begin to play an increasingly important role on the transportation market.

Therefore, highly efficient battery charging techniques are required. One example of an electrical charging system is described in the U.S. Pat. No. 6,215,277. Here, a control module selectively controls a charging current to one out of two batteries, which may have different output voltages. Thus, both the batteries can be charged without a DC-to-DC converter being required.

U.S. Pat. No. 6,462,511 discloses a pseudo-parallel charging system for charging segmented batteries, wherein a current switching device routes a charging current from a charge source to a selected battery segment while the remaining battery segments are in a relaxation mode, i.e. do not receive any charge current. Thereby, a cost-efficient solution for charging large battery packs is accomplished.

The U.S. Pat. No. 6,275,004 relates to an apparatus for balancing a battery module, wherein a plurality of batteries are connected in series to supply power to a vehicle. A generator voltage is here DC-to-DC converted and delivered individually to each battery in response to a measured charge condition of the specific battery. Thereby, the risk of a premature degradation of the batteries due to any imbalances in the state of charge (SOC) among the batteries may be reduced.

Hence, the prior art includes various examples of solutions for charging batteries which are advantageous with respect to different battery parameters, such as the cycle life (i.e. the number of times a battery may be recharged and discharged before it fails to meet a certain performance criterion).

However, there is yet no solution which significantly increases a battery's load capacity in respect of its usable SOC. Generally, if a voltage is fed to a battery which is equal to, or even below, the battery's nominal voltage, the battery will store an amount of energy which is less than its actual capacity. For example, a charging voltage equal to the nominal voltage may result in load capacity of 85% SOC for a standard lead-acid type of battery. By nominal voltage is here understood the output voltage which the battery is designed to deliver under normal operating conditions. Furthermore, no battery can drive a load with acceptable performance (i.e. relatively close to the nominal voltage) until it is fully discharged. Instead, the battery typically needs to be recharged when a 50%-SOC level has been reached. Consequently, if a standard battery is charged with a nominal voltage, its effective range of operation will be limited to an interval between 85% SOC and 50% SOC. Naturally, it is desirable to expand this interval and thus increase the battery's capacity.

One way to accomplish a broadening of the load-capacity interval is to supply a charging voltage which exceeds the nominal voltage, and thereby increase the upper SOC. As a general rule, the SOC increases with increasing charging voltage. However, it is far from unproblematic to elevate the charging voltage level. This may namely cause severe damage to the units which are included in the electric system being fed by the battery. For example, the service life of the light bulbs in a typical vehicle system may be reduced with up to 50% for each 0.5 Volt increase above the nominal voltage.

### SUMMARY OF THE INVENTION

The object of the present invention is therefore to provide an energy storage solution, which alleviates the problems above, and thus offers an efficient charging without increasing the risk of damaging any units that are included in the electric circuitry to which the charged storage module is coupled.

According to one aspect of the invention, the object is achieved by the arrangement for storing electrical energy as initially described, wherein the DC-to-DC converter is adapted to control each of the voltage fractions to vary over time within an interval around a respective nominal module voltage.

An important advantage attained by this arrangement is that, for each electrical storage module, the charging voltage may be temporarily increased to a level which is sufficiently high to obtain an improved load capacity (of, say 95% SOC). At the same time, the overall voltage over the electrical storage modules may be held at a nominal level, i.e. a harmless voltage with respect to any units that are included in the relevant electric circuitry.

According to one embodiment of this aspect of the invention, the interval represents a voltage variation of less than 25% of any of the nominal module voltages. This is namely sufficient to accomplish a significant improvement of the load capacity for a majority of the electrical storage modules types currently on the market. It is also important that the interval is held relatively narrow because otherwise the voltage level may become too low to maintain an adequate SOC in the modules during those periods when their voltage level is below the nominal value.

According to another embodiment of this aspect of the invention, the DC-to-DC converter is adapted to control the respective voltage fractions over the electrical storage modules, such that an average interval during which the voltage fraction exceeds the nominal module voltage is substantially equal with respect to all the modules. This is desirable because thereby all the modules obtain an equally good load capacity (provided, of course, that they have essentially the same electrochemical characteristics).

According to yet another embodiment of this aspect of the invention, the DC-to-DC converter is adapted to control the respective voltage fractions over the electrical storage modules, such that in average, an equally large fraction of the DC-system voltage is distributed to each module. Again, this is preferable from a load capacity point-of-view, at least if the modules have essentially the same electrochemical characteristics.

According to still another embodiment of this aspect of the invention, two or more of the electrical storage modules are included in a common battery unit. It is here presumed that a separate set of access points is provided for each module, and that these access points are coupled to the DC-to-DC converter, such that the modules may be charged individually. This design is advantageous, since in some applications it may be appropriate to enclose all, or at least some, of the modules in one battery unit, for example due for environmental reasons.

According to another embodiment of this aspect of the invention, the electrical storage modules are adapted to deliver energy to an electrical system of a vehicle via the first and second terminals. Naturally, this is desirable because in most vehicle applications, the storage modules will be required to deliver energy also during the normal charging procedure.

According to another aspect of the invention the object is achieved by a method of charging a number of electrical storage modules as initially described, wherein each of the voltage fractions is controlled to vary over time within an interval around a respective nominal module voltage. Thus, for each electrical storage module, the charging voltage may be temporarily increased to a level which is sufficiently high to obtain a significant improvement of the load capacity, without increasing the overall voltage to a level that may cause damages to any units that are included in the relevant electric circuitry.

According to one embodiment of this aspect of the invention, the interval represents a voltage variation of less than 25% of any of the nominal module voltages. As mentioned above, this is normally sufficient to improve the electrical storage modules' load capacity significantly in comparison with a standard nominal-voltage charging procedure.

According to another embodiment of this aspect of the invention, the respective voltage fractions over the electrical storage modules are controlled such that an average interval during which the voltage fraction exceeds the nominal module voltage is substantially equal with respect to all the modules. Namely, thereby all the modules obtain an equally good load capacity, at least if they have essentially the same electrochemical characteristics.

According to another embodiment of this aspect of the invention, the respective voltage fractions over the electrical storage modules are controlled such that, in average, an equally large fraction of the DC-system voltage is distributed to each module. As stated above, this is preferable from a load capacity point-of-view if the modules have essentially the same electrochemical characteristics.

According to a further aspect of the invention the object is achieved by a computer program directly loadable into the internal memory of a computer, comprising software for controlling the above proposed method when said program is run on a computer.

According to another aspect of the invention the object is achieved by a computer readable medium, having a program recorded thereon, where the program is to make a computer control the above proposed method.

Hence, the invention offers an excellent battery charging approach for any electrical system wherein a high load capacity is vital. The proposed solution is thereby particularly well suited for vehicle applications.

### BRIEF DESCRIPTION OF THE DRAWINGS

The present invention is now to be explained more closely by means of embodiments, which are disclosed as examples, and with reference to the attached drawings.

FIG. 1 shows a block diagram over an arrangement for storing electrical energy according to a first embodiment of the invention,

FIG. 2 shows graph for different charging voltages as functions of time according to the first embodiment of the invention,

FIGS. 3a-b show graphs specifically illustrating the charging voltages according to the first embodiment of the invention,

FIG. 4 shows a block diagram over an arrangement for storing electrical energy according to a second embodiment of the invention,

FIG. 5 shows graph for different charging voltages as functions of time according to the second embodiment of the invention,

FIGS. 6a-c show graphs specifically illustrating the charging voltages according to the second embodiment of the invention, and

FIG. 7 shows a flow diagram which illustrates the general method according to the invention.

### DESCRIPTION OF EMBODIMENTS OF THE INVENTION

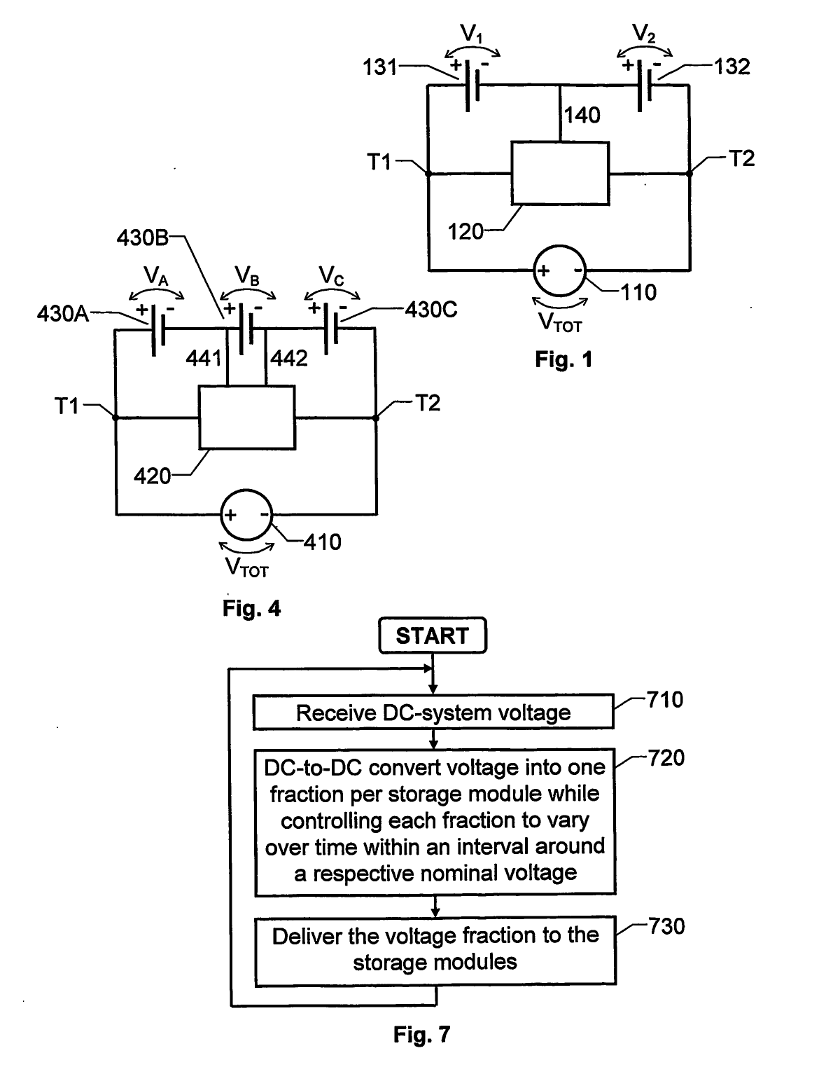

A block diagram over an arrangement for storing electrical energy according to a first embodiment of the invention is shown in FIG. 1. The arrangement includes an electric charge source 110, such as a DC-generator, a DC-to-DC converter 120 and first and second electrical storage modules 131 and 132 respectively, for example in the form of lead acid batteries.

The electric charge source 110 produces a DC-system voltage V_{TOT} and is connected to a first and a second terminal T1 and T2 respectively, such that the DC-system voltage V_{TOT} is applied between the first terminal T1 and the second terminal T2.

The electrical storage modules 131 and 132 are connected in series to one another with a first terminal polarity, e.g. negative, of the first module 131 coupled to a second terminal polarity, e.g. positive, of the second module 132. The first electrical storage module 131 is also connected to the first terminal T1 with a second terminal polarity, e.g. positive, and correspondingly, the second electrical storage module 132 is connected to the second terminal T2 with a first terminal polarity, e.g. negative. Thus, the DC-system voltage V_{TOT} is applied over the electrical storage modules 131 and 132.

The DC-to-DC converter 120 is coupled to both the terminals T1 and T2, and to a point between the first and second modules 131 and 132 by means of an electrical connection 140. In practice, this connection point may be identical to one of the module's 131 or 132 terminals. The DC-to-DC converter 120 receives incoming power from the electric charge source 110 via the terminals T1 and T2. The DC-to-DC converter 120 also delivers a voltage fraction V₁ and V₂ of the DC-system voltage V_{TOT} to each of the modules 131 and 132. By means of the electrical connection 140, the DC-to-DC converter 120 controls the voltage fractions V₁ and V₂, such that they vary over time. However the sum of V₁ and V₂ is always equal to the DC-system voltage V_{TOT}.

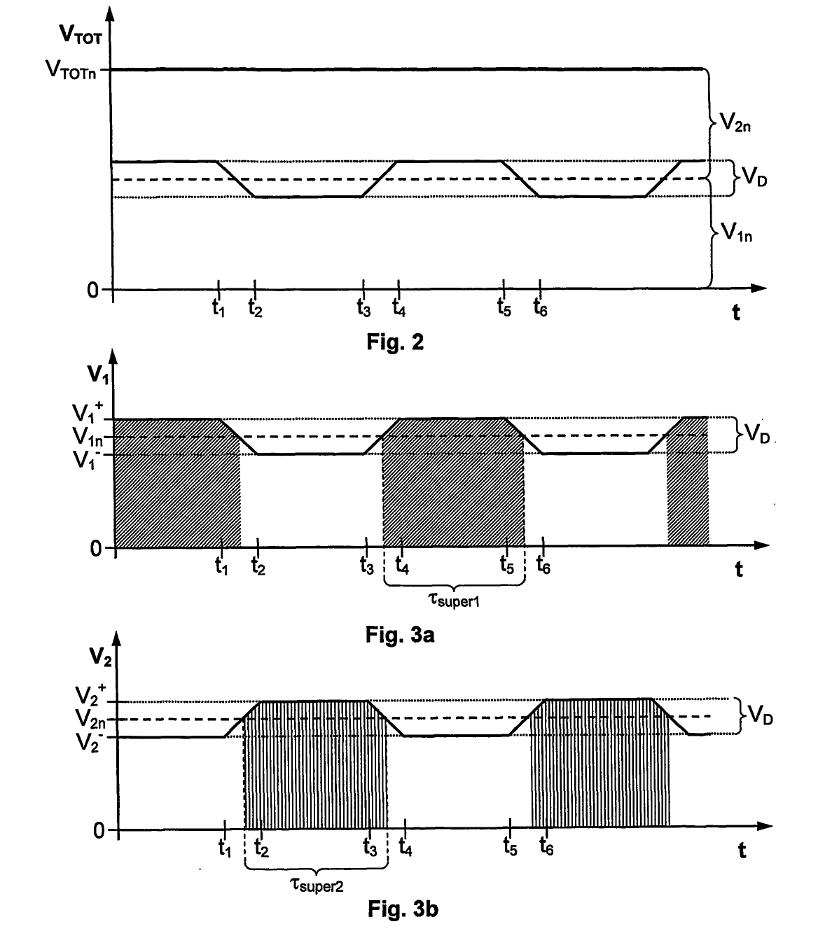

FIG. 2 shows a first graph which illustrates how the voltage fractions V₁ and V₂ may be varied over time. The diagram's vertical axis indicates the DC-system voltage V_{TOT}, which here is assumed to remain essentially constant at a nominal level T_{TOTn}. Theoretically, however, the DC-system voltage V_{TOT} may vary, and in practice it often fluctuates to some degree, although a constant voltage value is generally desirable. The horizontal axis of the diagram indicates the time t.

A dashed line represents a first nominal voltage value V₁ₙ for a first voltage fraction V₁ over the first electrical storage module 131. In this example, the first nominal voltage value V₁ₙ is equal to V_{TOT}/2, however any other value is technically conceivable. Since the first nominal voltage value V₁ₙ here is V_{TOT}/2, a second nominal voltage value V₂ₙ for the second voltage fraction V₂ over the second electrical storage module 132 also becomes V_{TOT}/2.

The voltage fractions V₁ and V₂ are varied within an interval V_{D} around the respective nominal module voltage V₁ₙ and V₂ₙ. According to this embodiment of the invention, the voltage fractions V₁ and V₂ over the respective modules 131 and 132 vary over time t by periodically applying a voltage V₁ above the first nominal voltage value V₁ₙ over the first module 131 while applying a voltage V₂ below the second nominal voltage value V₂ₙ over the second module 132, and vice versa. Specifically, at a first time instance t₁ a gradual decrease of the first voltage fraction V₁ is initiated from an upper voltage level V₁₊, and at a second time instance t₂ a lower voltage level V₁₋ is reached. The difference between the upper voltage level V₁₊, and the lower voltage level V₁₋ thus represents the interval V_{D}. Preferably, the first nominal voltage value V₁ₙ corresponds to the average value of the upper voltage level V₁₊, and the lower voltage level V₁₋. FIG. 3a shows a graph which illustrates the specific variation of the first voltage fraction V₁. At a third time instance t₃, a gradual increase of the first voltage fraction V₁ is initiated, and at a fourth time instance t₄, the upper voltage level V₁₊ is again reached. At yet a later time fifth time instance t₅, the first voltage fraction V₁ is lowered once more until the lower voltage level V₁₋ is reached at a sixth time instance t₆, and so on.

Consequently, during a first interval τₛᵤₚₑᵣ₁ starting between the third and fourth time instances t₃ and t₄, and ending between the fifth and sixth time instances t₅ and t₆, the first voltage fraction V₁ exceeds the first nominal module voltage V₁ₙ. The charging performed during this first interval τₛᵤₚₑᵣ₁ may thereby drive such an amount of energy into the first electrical storage module 131 that it obtains a relatively good load capacity. If, for example, the first nominal module voltage V₁ₙ is 14 Volts, and the upper voltage level V₁₊ is 15 Volts, a load capacity of 95% SOC may be accomplished.

FIG. 3b shows a graph which illustrates a corresponding variation of the second voltage fraction V₂. Here, a second interval τₛᵤₚₑᵣ₂ during which the second voltage fraction V₂ exceeds the second nominal module voltage V₂ₙ starts between the first and second time instances t₁ and t₂, and ends between the third and fourth time instances t₃ and t₄. Thus, the charging performed during the second interval τₛᵤₚₑᵣ₂ may drive such an amount of energy into the second electrical storage module 132 that also this module obtains a relatively good load capacity.

A variation of the voltage fractions V₁ and V₂ between 13 Volts and 15 Volts as exemplified above, is equivalent to the interval V_{D} representing a voltage variation of 2/14≈14% of the nominal module voltages V₁ₙ and V₂ₙ (which are both 14 Volts). Such a variation is normally sufficient to ensure a first-rate load capacity of the electrical storage modules. In any case, according to one embodiment of the invention, the interval V_{D} represents a voltage variation of less than 25% of any of the nominal module voltages V₁ₙ and V₂ₙ.

Moreover, the DC-to-DC converter controls the respective voltage fractions V₁ and V₂ over the electrical storage modules 131 and 132 respectively, such that the first and second intervals τₛᵤₚₑᵣ₁ and τₛᵤₚₑᵣ₂ are approximately equal, at least on average. Thereby, both the modules 131 and 132 will have essentially the same load capacity (provided that their electrochemical characteristics are essentially the same). Nevertheless, the length of the intervals during which the voltage fractions V₁ and V₂ are temporarily constant, (e.g. between t₂ and t₃; and between t₄ and t₅ respectively) is arbitrary and may be made infinitely short (i.e. t₂=t₃ and t₄=t₅), such that voltage fractions V₁ and V₂ vary continuously.

Although in many applications it may be desirable to control the respective voltage fractions V₁ and V₂, such that they voltage, on average, are substantially equally large, this is not necessary from a technical point of view. On the contrary, the nominal voltage values may very well be individually different. Furthermore, the super charging intervals (e.g. τₛᵤₚₑᵣ₁ and τₛᵤₚₑᵣ₂ above) may have different extensions in time.

FIG. 4 shows a block diagram over an arrangement for storing electrical energy according to a second embodiment of the invention, which elucidates these aspects of the invention. The arrangement includes an electric charge source 410, for example in the form of a DC-generator, a DC-to-DC converter 420 and first, second and third electrical storage modules 430A, 430B and 430C respectively, which may be lead acid batteries.

Also in this case, the electric charge source 410 produces a DC-system voltage V_{TOT} between a first terminal T1 and a second terminal T2. Moreover, the electrical storage modules 430A, 430B and 430C are all connected in series to one another with alternating terminal polarities. A first electrical storage module 430A is further connected to the first terminal T1 and a third electrical storage module 430C is connected to the second terminal T2. Thus, the DC-system voltage V_{TOT} is applied over all the electrical storage modules 430A, 430B and 430C.

The DC-to-DC converter 420 is electrically coupled to both the terminals T1 and T2, and to one point between each of the first, second and third modules 430A, 430B and 430C by means of respective electrical connections 441 and 442. The DC-to-DC converter 420 receives incoming power from the electric charge source 410 via the terminals T1 and T2. The DC-to-DC converter 420 also delivers a voltage fraction V_{A}, V_{B}, and V_{C} of the DC-system voltage V_{TOT} to each of the modules 430A, 430B and 430C. Via the electrical connections 441 and 442, the DC-to-DC converter 420 controls the voltage fractions V_{A}, V_{B}, and V_{C}, such that they vary over time. However the sum of V_{A}, V_{B}, and V_{C} is always equal to the DC-system voltage V_{TOT}.

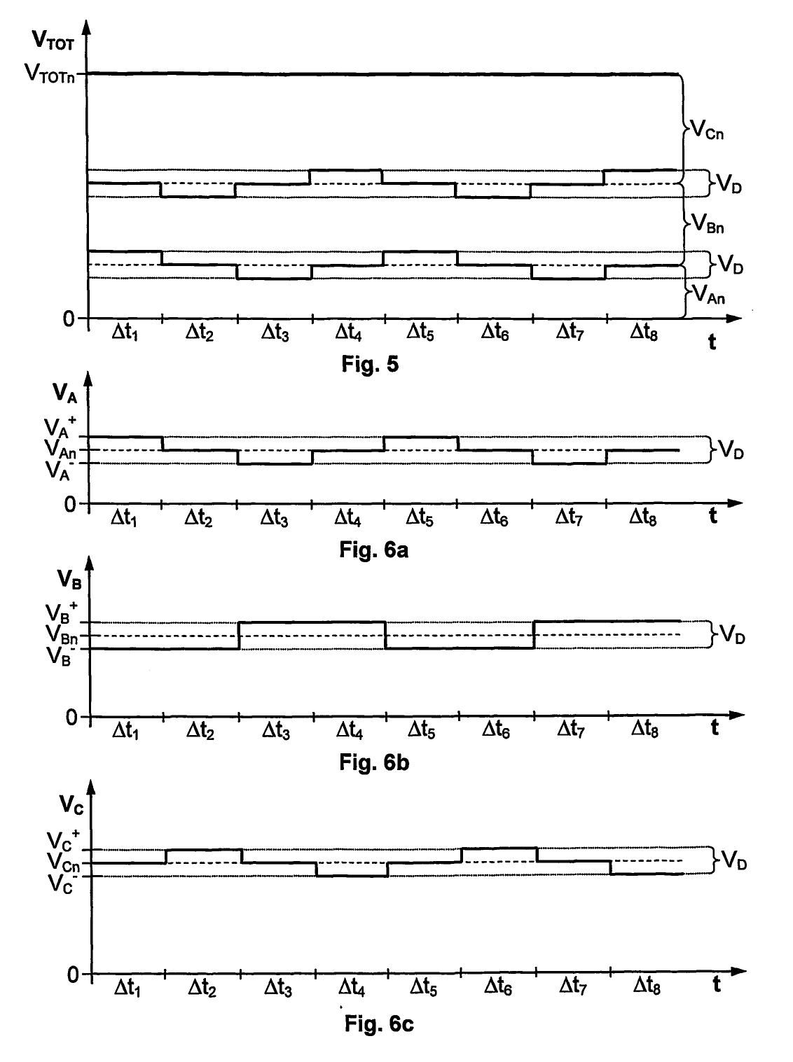

FIG. 5 shows graph (corresponding to the graph in FIG. 2) which illustrates how the voltage fractions V_{A}, V_{B}, and V_{C} may be varied over time. As is apparent from the FIG. 5, a first nominal voltage value V_{An} for the first voltage fraction V_{A} over the first electrical storage module 430A is lower than a second nominal voltage value V_{Bn} for the second voltage fraction V_{B} over the second electrical storage module 430B. The second nominal voltage value V_{Bn}, in turn, is lower than a third nominal voltage value V_{Cn} for the third voltage fraction V_{C} over the third electrical storage module 430C.

Also in this example, the DC-system voltage V_{TOT} is assumed to remain essentially constant at a nominal level V_{TOTn}, while the voltage fractions V_{A}, V_{B}, and V_{C} are varied over time t. All variations, however, are held within an interval V_{D} around the respective nominal voltage value V_{An}, V_{Bn}, and V_{Cn}.

FIG. 6a shows a graph which specifically illustrates how the first voltage fraction V_{A} is varied over time t. The DC-to-DC converter 420 initially controls the first voltage fraction V_{A} to a first upper voltage level V_{A+} above the first nominal voltage value V_{An} during a first interval tΔ₁. During a subsequent second interval tΔ₂, the first voltage fraction V_{A} is controlled to the first nominal voltage value V_{An}, and during a following third interval tΔ₃, the first voltage fraction V_{A} is controlled to a first lower voltage level V_{A-} below the first nominal voltage value V_{An}. Then, during a fourth interval tΔ₄, the first voltage fraction V_{A} is again controlled to the first nominal voltage value V_{An}. The fourth interval tΔ₄, completes a full period, such that a subsequent fifth interval tΔ₅ is equivalent to the first interval tΔ₁.

FIG. 6b shows a corresponding graph specifically illustrating how the second voltage fraction V_{B} is varied over time t. The DC-to-DC converter 420 here controls the second voltage fraction V_{B} to, during the first and the second intervals tΔ₁ and tΔ₂, attain a voltage value which is given by a second lower voltage level V_{B} below the second nominal voltage value V_{Bn}. Then, during the third and the fourth intervals tΔ₃ and tΔ₄, the second voltage fraction V_{B} is controlled to a voltage value represented by a second upper voltage level V_{B+} above the second nominal voltage value V_{Bn}. A following fifth interval tΔ₅ is equivalent to the first interval tΔ₁.

Finally, FIG. 6c shows a graph which specifically illustrates how, in this example, the third voltage fraction V_{C} is varied over time t. During the first interval tΔ₁, the third voltage fraction V_{C} is controlled to the third nominal voltage value V_{Cn}, and during the second interval tΔ₂ it is controlled to attain a voltage value given by a third upper voltage level V_{C+} above the third nominal voltage value V_{Cn}. Subsequently, during the third interval tΔ₃, the third voltage fraction V_{C} is again controlled to the third nominal voltage value V_{Cn}, and during the fourth interval tΔ₄, the third voltage fraction V_{C} is controlled to a voltage value at a third lower voltage level V_{C-} below the third nominal voltage value V_{Cn}. In analogy with the above, these four intervals tΔ₁-tΔ₄ completes a full period, such that a following fifth interval tΔ₅ is equivalent to the first interval tΔ₁.

Thus, both the first voltage fraction V_{A} and the third voltage fraction V_{C} are varied over time t, such that they periodically attain their respective nominal voltage values V_{An} and V_{Cn}, namely during every second interval. The second voltage fraction V_{B}, however, is controlled such that it never attains its nominal voltage value V_{Bn}. It is nevertheless worth noticing that the DC-to-DC converter 420 controls all the voltage fractions V_{A}, V_{B} and V_{C} to vary within the interval V_{D} around their respective nominal voltage value V_{An}, V_{Bn} and V_{Cn}. According to one embodiment of the invention, the interval V_{D} represents a voltage variation of less than 25% of any of the nominal module voltages V_{An}, V_{Bn} and V_{Cn}.

In order to sum up, the general method of charging a number of electrical storage modules according to the invention will now be described with reference to a flow diagram in FIG. 7.

A first step 710 receives the DC-system voltage, for example between a first and a second terminal. A subsequent step 720, converts the DC-system voltage into one voltage fraction per module. The step 720 also varies each voltage fraction over time within an interval around the respective nominal module voltage. Finally, a step 730 delivers the relevant voltage fractions to each of the modules.

Naturally, the steps 710, 720 and 730 are actually performed continuously and in pseudo-parallel to each other, such that a DC-system voltage received in the step 710 essentially immediately is delivered to the electrical storage modules via the step 730.

All of the process steps, as well as any sub-sequence of steps, described with reference to the FIG. 7 above may be controlled by means of a programmed computer apparatus. Moreover, although the embodiments of the invention described above with reference to the drawings comprise computer apparatus and processes performed in computer apparatus, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The carrier may be any entity or device capable of carrying the program. For example, the carrier may comprise a storage medium, such as a ROM (Read Only Memory), for example a CD (Compact Disc) or a semiconductor ROM, or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

The term “comprises/comprising” when used in this specification is taken to specify the presence of stated features, integers, steps or components. However, the term does not preclude the presence or addition of one or more additional features, integers, steps or components or groups thereof.

The invention is not restricted to the described embodiments in the figures, but may be varied freely within the scope of the claims.

1. An arrangement for storing electrical energy comprising:
an electric charge source operable to produce a DC-system voltage between a first terminal and a second terminal,
a plurality of electrical storage modules connected in series between the first terminal and the second terminal, each electric storage module having a respective nominal module voltage;
a DC-to-DC converter coupled to the electric charge source and to each of the electrical storage modules, the DC-to-DC converter being operable to receive incoming power from the electric charge source and to deliver a respective voltage fraction of the DC-system voltage to each of the modules
wherein the DC-to-DC converter is operable to control each of the voltage fractions to vary each fraction over time within a voltage interval around the respective nominal module voltage of each module.

2. An arrangement according to claim 1, wherein the voltage interval represents a voltage variation of less than 25% of any of the nominal module voltages.

3. An arrangement according to claim 1, wherein the DC-to-DC converter is operable to control the respective voltage fractions over the electrical storage modules such that an average time interval during which the voltage fraction exceeds the nominal module voltage is substantially equal with respect to all the modules.

4. An arrangement according to claim 1, wherein the DC-to-DC converter is operable to control the respective voltage fractions over the electrical storage modules such that an average fraction of the DC-system voltage being distributed to each module is substantially equally large for all the modules.

5. An arrangement according to claim 1, wherein at least two of the electrical storage modules are included in a common battery unit, the unit having a separate set of access points for each module, and each of the access points is coupled to the DC-to-DC converter.

6. An arrangement according to claim 5, wherein there are two of electrical storage modules.

7. An arrangement according to claim 1, wherein the electrical storage modules are operable to provide power to an electrical system of a vehicle via the first and second terminals.

8. An arrangement according to claim 1, wherein the electric charge source is an electric generator.

9. A motor vehicle, comprising an arrangement for storing electrical energy according to claim 1.

10. A method of charging a plurality of electrical storage modules comprising the steps of connecting the modules in series between a first terminal and a second terminal;
receiving a DC-system voltage between the first terminal and the second terminal,
DC-to-DC converting the DC-system voltage into a respective voltage fraction per module;
delivering its respective voltage fraction to each of the modules, and
controlling each of the voltage fractions to vary over time within a voltage interval (V_{D}) around a respective nominal module voltage.

11. A method according to claim 10, wherein the voltage interval represents a voltage variation of less than 25% of any of the nominal module voltages.

12. A method according to claim 10, further comprising controlling the respective voltage fractions over the electrical storage modules such that an average time interval during which the voltage fraction exceeds the respective nominal module voltage is substantially equal with respect to all the modules.

13. A method according to claim 10, further comprising controlling the respective voltage fractions over the electrical storage modules such that an average fraction of the DC-system voltage being distributed to each module is substantially equally large for all the modules.

14. A method according to claim 10, wherein there are two electrical storage modules.

15. A computer program directly loadable into the internal memory of a computer, comprising software for controlling steps when the program is run on the computer, the steps being controlled comprising
receiving a DC-system voltage between the first terminal and the second terminal,
DC-to-DC converting the DC-system voltage into a respective voltage fraction per module;
delivering its respective voltage fraction to each of the modules, and
controlling each of the voltage fractions to vary over time within a voltage interval (V_{D}) around a respective nominal module voltage.

16. A computer readable medium, having the program of claim 15 recorded thereon.

17. An arrangement according to claim 1, wherein the DC-to-DC converter is operable to control the voltage fractions such that when one of the voltage fractions is varied to be above the respective module, another of the voltage fractions is varied to be below the respective normal module voltage for another respective module.

18. A method according to claim 10, wherein each of the voltage fractions is controlled such that when one of the voltage fractions is varied to be above the respective module, another of the voltage fractions is varied to be below the respective normal module voltage for another respective module.
